(19) United States
(12) Patent Application Publication
(10) Pub. No.: US 2022/0395964 A1
(43) Pub. Date: Dec. 15, 2022

(54) PLIERS-TYPE TOOL WITH ROTATABLE JAWS

(71) Applicant: Shay MAMDAR, Or Yehuda (IL)

(72) Inventor: Shay MAMDAR, Or Yehuda (IL)

(21) Appl. No.: 17/776,360

(22) PCT Filed: May 23, 2021
(86) PCT No.: PCT/IL2021/050595

§ 371 Date: May 12, 2022

(30) Foreign Application Priority Data
May 31, 2020 (IL) 275022

(51) Int. Cl. B25B 7/08; B25B 7/02

(52) U.S. Cl. CPC B25B 7/08; B25B 7/02

(57) ABSTRACT

The present invention discloses pliers type tool with rotatable jaws where the angle between the jaws and the handles can be easily changed for best adapting the tool for its use. It is comprised of two handles which have circular driving plates on one end and user's grasping area. The jaws are attached to circular plates which are placed between the circular plates of the handles. All circular plates have a hole in the center through which a pivot is inserted. The circular plate of the jaw is coupled to the circular plate of the handle by a pin inserted by a lever. The circular plate attached to the jaw has plurality of annular set of holes, and the circular plate of the handle has just one hole. Thus the jaws can be coupled at different angles to the handled of the tools.

### TECHNICAL FIELD

The present invention generally relates to the field of hand-held tools, and more specifically to handheld tools with jaws on pivoted limbs that can be rotated relative to the tool handles.

### BACKGROUND ART

Plier-type tools typically comprise two handles which are permanently attached to two jaws. Various types of jaws can be permanently attached to the handles to provide pliers, wire cutters, wire strippers, sheet metal cutting devices etc.

There are pliers type tools that have two pairs of jaws mounted one opposite the other. Each pair of jaws can be put in use or non-use position by rotating the handles be 180 degrees. Such a tool is described in U.S. Pat. No. 6,223,374.

The center line of the jaws is aligned with the center line of the handles. However, there are many situations where it is difficult for conventional pliers-type tool to access the object to be manipulated on. In such cases, a tool with rotated jaws relative to the handles can enable good access to the manipulated object.

U.S. Pat. No. 7,451,673 “Indexable Pliers-Type Tool” by K. A Peterson, describes such a tool. In the tool described in the patent, the jaws can be positioned in plurality of angular positions relative to the tool handles. However, the mechanism used to obtain such tool flexibility is expensive.

U.S. Pat. No. 6,976,412 “Tool Equipped With A Turnable Driving Head” by M. C. Yu, describes a different mechanism that enables to position the jaws of an hand-tool in plurality of angular positions relative to the handles. This mechanism is limiting the number of angular positions.

There is a need for an easy to operate, turnable hand tool.

### SUMMARY OF INVENTION

The present invention discloses pliers type tool with rotatable jaws where the angle between the jaws and the handles can be easily changed for best adapting the tool for its use.

The primary object of the invention is to provide a tool equipped with turntable driving head. It is also an object of the invention to provide such a rotatable tool that can be used for various operations by replacement of the attached jaws.

The tool is comprised of two handles which have circular driving plates on one end and user's grasping area. The jaws are attached to circular plates which are placed between the circular plates of the handles on the other end. All circular plates have a hole in the center through which a pivot is inserted. The circular plate of the jaw is coupled to the circular plate of the handle by a pin inserted by a lever. The circular plate attached to the jaw has plurality of annular set of holes, and the circular plate of the handle has just one hole. Thus, the jaws can be coupled at different angles to the handles of the tools.

The forgoing, as well as additional objects, features and advantages of the invention, will be more readily apparent from the following detailed description which proceeds with the accompanying drawings.

### BRIEF DESCRIPTION OF DRAWINGS

FIG. 1 is a perspective view of an embodiment of the present invention.

FIG. 2 is an exploded view of an embodiment of the present invention.

FIG. 3 is a perspective view of another embodiment detail of the mechanism.

### DETAILED DESCRIPTION

The invention will be described more fully hereinafter, with reference to the accompanying drawings. The invention may, however, be embodied in many different forms and should not be construed as limited to the embodiments set forth herein; The presented fully convey the scope of the invention to those skilled in the art.

In the following description, the same numerical references refer to similar elements. The embodiments, geometrical configurations, materials mentioned and/or dimensions shown in the figures or described in the present description are embodiments only, given solely for exemplification purposes.

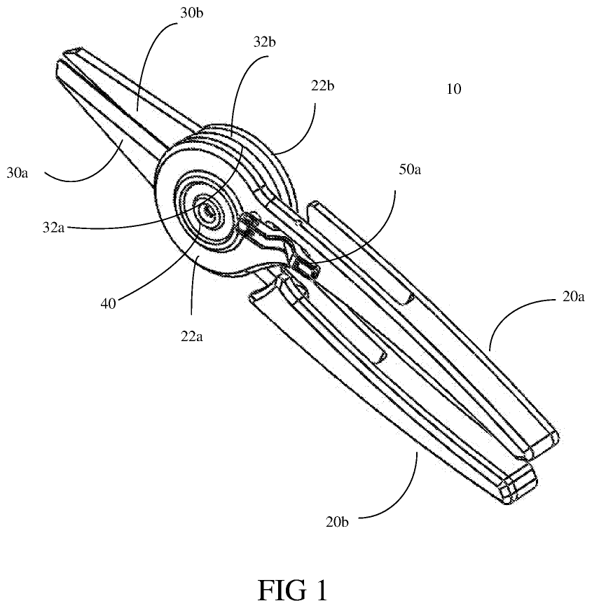

FIG. 1 presents a perspective view of an embodiment of the present invention. The pliers type tool with rotatable jaws 10, is comprised of two handles, each having rear end 20a and 20b to be grasped by user's hands for wrenching and a driving plates 22a and 22b respectively on the front end. There are two jaws, 30a and 30b which are rigidly attached to driven plates 32a and 32b, respectively. A coupling element, 40 which functions as a pivot, is inserted through holes in the driving plates 22a and 22b and through holes (not shown in FIG. 1) in the driven plates 32a and 32b.

Also shown in FIG. 1 is one lever, 50a which enables to insert a pin which attaches the driving plate 22a to the driven plate 32a. Similar lever 50b, exists for driving plate 22b and driven plate 32b.

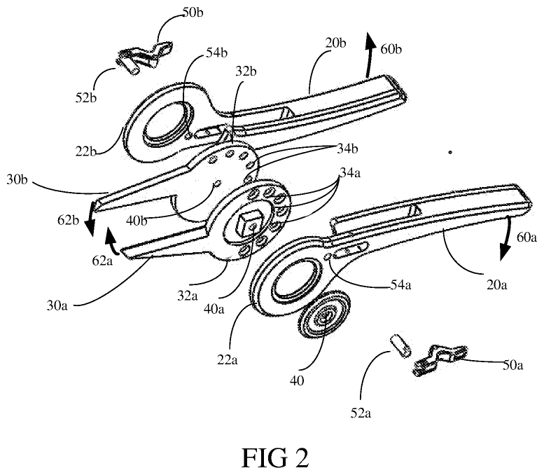

An exploded view of an embodiment of the present invention is presented in FIG. 2. Here detailed description of the jaw's rotation mechanism can be seen. The pliers type tool with rotatable jaws 10, is comprised of two handles, each having rear end 20a and 20b to be grasped by user's hands for wrenching and a driving plates 22a and 22b respectively on the front end. There are two jaws, 30a and 30b which are rigidly attached to driven plates 32a and 32b, respectively.

The driven plates 32a and 32b are circular shaped and they have plurality of annular set of holes 34a and 34b. These holes are opposite holes 54a and 54b drilled on the handles driving plates 22a and 22b, respectively. In addition, there are holes in the center of the driven plates 22a and 22b through which the coupling pin 40 functioning as a pivot is inserted. When pin 52a is inserted into hole 54a in the handle's driving plate 22a, it enters one of the holes 34a in the driven plate 32a. Similarly, when pin 52b is inserted into hole 54b in the handle driving plate 22b, it enters one of the holes 34b in the driven plate 32b. Thus, movement the rear end of handle 20a down, in the direction of arrow 60a causes the jaw 30a to move up in the direction pointed by vector 62a. Similarly, movement the rear end of handle 20b up, in the direction of arrow 60b causes the jaw 30b to move down in the direction pointed by vector 62b.

When the levers 50a and 50b are released, the pins 52a and 52b exit the holes in the driven plates 32a and 32b. In that state the jaws and the driven plates can be rotates to the desired angle, and the levers 50a and 50b are activated, i.e. the pins 52a and 52b are entering the holes in the driven plates.

Note that the jaws can have any desired shape, such as cutter blade, stripper blade, pincer jaws etc. In another embodiment the jaws may be attached to the driven plate with removable mechanism, or they can be manufactured as one unit with the driven plate.

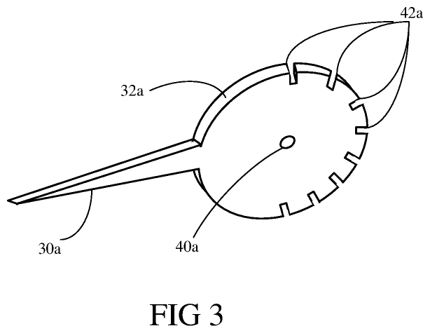

In FIG. 3 another implementation of the driven plate mechanism is presented. In that case, instead of having tabular holes as 34a, 34b in FIG. 2, there are slots 42a on the outer circumference of the driven plate—FIG. 3. In that case there are also slots on the outer circumference of the driving plates. In that implementation the release lever is mounted on one handle perpendicular to the plane of the driving plates. In that case, the circular pins 52a and 52b are replaced by rectangular bars which, when engaged, are inserted into the slots on the circumference of the driving and driven plates.

What has been described above are just a few possible embodiments of the disclosed innovation. One of ordinary skill in the art may recognize that many further combinations and permutations are possible. Accordingly, the innovation is intended to embrace all such alterations, modifications, and variations that fall within the spirit and scope of the invention.

What is claimed is:

1. Pliers type tool with rotatable jaws, where the tool is comprised of:
a) two handles, each having rear end to be grasped by user's hands for wrenching and a circular shaped driving plate on the front end;
b) said driving plate has a circular hole in the center and one circular hole off centered;
c) two jaws rigidly attached to circular shaped driven plates;
d) said driven plates are positioned one next to the other between the driving plates; each driven plate has a circular hole in the center and annular set of equal sized circular holes; the radius of each circular hole of the annular set is equal to the size of the off centered circular hole in the driving plates; the distance between the center hole of the driven plate and the annular set of holes equals the distance between the center hole of the driving plates to the off centered hole of the driving plates;
e) a pivot that is inserted through the center circular holes of the driving plates and the driven plates;
f) a pin attached to a lever positioned on each handle, that can be inserted through the off centered circular hole of the driving plate into one of the annular circular holes of the driven plate; the length of the pin equals the thickness of one driving plate plus the thickness of one driven plate.

2. The pliers type tool with rotatable jaws as in claim 1, wherein the jaws attached to the driven plates can be used for cutting.

3. The pliers type tool with rotatable jaws as in claim 1, wherein the jaws attached to the driven plates can be used for wire stripping.

4. The pliers type tool with rotatable jaws as in claim 1, wherein the jaws attached to the driven plates can be used for gripping.

5. The pliers type tool with rotatable jaws as in claim 1, wherein the jaws can be attached to the driven plates by a coupling mechanism.

6. Pliers type tool with rotatable jaws, where the tool is comprised of:
a) two handles, each having rear end to be grasped by user's hands for wrenching and a circular shaped driving plate on the front end;
b) said driving plate has a hole in the center and plurality of slots on the circumference;
c) two jaws rigidly attached to circular shaped driven plates;
d) said driven plates are positioned one next to the other between the driving plates and have slots on the circumference, matching the slots in the driving plate;
e) a pivot that is inserted through the center holes of the driving plates and the driven plates;
f) a pin attached to a lever positioned on each handle, that can be inserted into the slots of a couple of driving and driven plates.

7. The pliers type tool with rotatable jaws as in claim 6, wherein the jaws attached to the driven plates can be used for cutting.

8. The pliers type tool with rotatable jaws as in claim 6, wherein the jaws attached to the driven plates can be used for wire stripping.

9. The pliers type tool with rotatable jaws as in claim 6, wherein the jaws attached to the driven plates can be used for gripping.

10. The pliers type tool with rotatable jaws as in claim 6, wherein the jaws can be attached to the driven plates by a coupling mechanism.
